(19) United States
(12) Patent Application Publication
(10) Pub. No.: US 2010/0312464 A1
(43) Pub. Date: Dec. 9, 2010

(54) ADVICE ENGINE DELIVERING PERSONALIZED SEARCH RESULTS AND CUSTOMIZED ROADTRIP PLANS

(76) Inventors: Chicke Fitzgerald, Tampa, FL (US); David Vis, St. Pete Beach, FL (US)

Correspondence Address: FOX ROTHSCHILD LLP;New York, 997 Lenox Drive, Bldg. #3, Lawrenceville, NJ, 08648, US

(21) Appl. No.: 12/113,911

(22) Filed: May 1, 2008

Related U.S. Application Data
(60) Provisional application No. 60/915,425, filed on May 1, 2007.

(51) Int. Cl. G06F 15/16; G01C 21/00; G06F 3/01

(52) U.S. Cl. 701/200; 715/748

(57) ABSTRACT

Disclosed herein is a system and method, utilizing a proprietary content database and associated support services, for providing comprehensive, customized trip planning and related mapping and routing services.

### RELATED APPLICATIONS

The present application relates to and claims priority to U.S. Provisional Patent Application Ser. No. 60/915,425 filed May 1, 2007.

### FIELD OF THE INVENTION

The present invention relates generally to a system and method, utilizing a proprietary content database and associated support services, for providing comprehensive, customized trip planning and related mapping and routing services.

### BACKGROUND OF THE INVENTION

In the course of life, a particular task, such as planning a journey, can quite often require an individual to access multiple sources of media and information in order to carry out that task, which can be time consuming and, when taken to an extreme, quite onerous. The tasks we address have to do with the combination of numerous things that are required in planning a journey each time you get in your car, from tooling around town and needing to find the closest Thai restaurant to your new friend's house, figuring out something “off the beaten path” to do with the kids on a Saturday on a day trip (and inside activities only because there is a 100% chance of rain), to planning a weekend trip or trip for a class reunion, wedding, funeral, a vacation or just a romantic getaway.

The present invention, marketed in a commercial embodiment as the Journey Wizard^{SM}, combines a number of separate functions that heretofore, to the extent that they have existed at all, have existed only as separate elements of prior art processes and services.

Just as Apple's iPhone® brought forward the convergence of the PDA, the phone, the navigation device, a camera and a music player, the Journey Wizard embodiment of the present invention sits at a similar crossroads, leading the convergence of three very separate and distinct, and exciting, marketplaces—trip planning and booking, content and community, and mapping and navigation.

Trip Planning and Booking Trip planning and booking includes the process of deciding where to go and what to do, based on who you are with, how you are getting there, when you are going and why you are traveling to begin with. It includes searching out information about various points of interest (places to stay, places to eat, places to go, things to do, things you need along the way) and events to attend. Once you have selected certain key elements of the trip, such as lodging or determined that you need to fly into one place and rent a car to get to another, you also need to book/reserve and often pre-pay for those items. Planning the entire trip and having a consolidated itinerary, not only for booked items but for other non-traditional items, such as your Aunt Sally's home address in Bellingham, Wash. and your sister's favorite custard stand in Seattle, and having the dates of the street fair in Eugene, Oreg. These items are an essential part of a complete trip-planning function. These functions have previously been strewn across travel web sites, through interaction with a professional travel agent or concierge, destination and genre sites, and information portals and search engines. Consumers consult guidebooks and watch TV shows about destinations and various experiences but then are left to fend for themselves to try to create or re-capture the trip.

Content and Community Content and community elements consist of having information about a broad range of points of interest across a broad geography, with feedback inserted by individuals that have experienced the points of interest. Today, there are various sites that have lots of content and even user-generated feedback and ratings, but there is very little ability to assimilate what is read into an actual experience, without putting together a disparate sheaf of papers, maps, etc. that is unwieldy, at best. Currently user-generated feedback and ratings have minimal value on community sites if not categorized by the circumstances behind the users' experience. For instance, an individual that loved a given hotel [when traveling with their 5 children under aged 10] writes a review on Trip Advisor. A couple looking for a romantic getaway just reads “we loved it,” but truly should discount it as a possibility for a quiet place to stay. This is not possible without the digital persona (referred to as an “eTwin”) component of the present invention, which component provides an automatic and electronic internal validation for every user-generated comment and rating.

Mapping, Routing and Navigation Mapping, routing and navigation are key functions of travel and journey planning, which also includes the integration of geo-coded, location-based content. Ten out of the top twenty search terms in the travel category include mapping and driving directions, yet the travel industry has largely missed the opportunity to take this category and meld it with travel, much like the melding of chocolate & peanut butter to make a peanut butter cup.

### BRIEF DESCRIPTION OF THE DRAWINGS

FIG. 1 is a schematic representation of a commercial embodiment of the system and method of the present invention.

FIG. 2 is an illustration of a user view of the commercial embodiment of the current invention.

FIG. 3 illustrates graphically a set of “applets” implemented in the practice of the present invention.

FIG. 4 graphically illustrates various components of certain features of the system of the invention.

FIG. 5 illustrates an example of input portlets as used by consumers in interacting with the system of the present invention.

FIG. 6 is a graphical representation of the Trip Suitcase metaphor for a component of a commercial embodiment of the system of the invention.

FIG. 7 is a schematic representation of the “back office” tools associated with the functioning of the system of the invention.

FIG. 8 is a depiction of a representative browser screen as seen by a user of a commercial embodiment of the invention illustrating a “landing page” associated with a linked third-party service provider.

FIG. 9 is a sample Web browser page showing editorial content from which the system of the present invention can automatically extract trip profiles for storage and later use.

FIG. 10 is a graphical representation of print publications providing coded links to stored trip profiles that are available to users for adoption and/or modification.

### DETAILED DESCRIPTION OF THE INVENTION

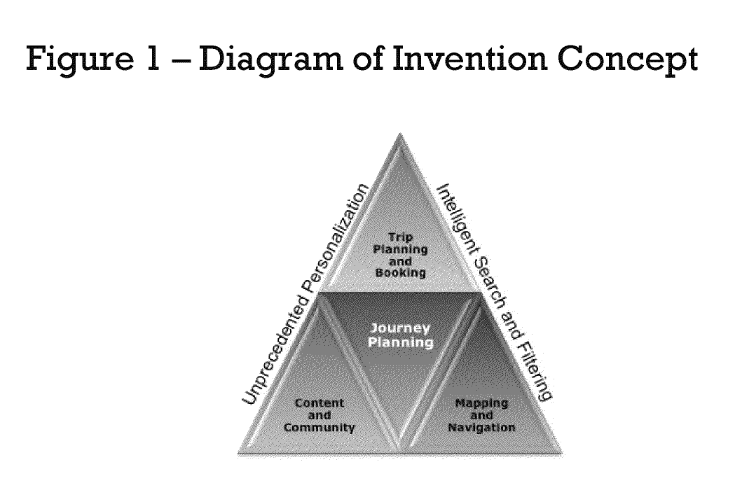

A commercial embodiment of the present invention, marketed as the Journey Wizard^{SM} product, includes a convergence of various categories of novel processes in the trip planning and booking, content and community, and mapping and navigation arenas into a new capability known as journey planning. This is illustrated as FIG. 1.

Journey planning tools associated with the practice of the present invention provide unprecedented personalization, through the use of intelligent, filtered search capability using fuzzy logic. This function is based on multi-dimensional, multi-faceted profiles that allow for intent-based, situational personalization. These profiles, referred to in a commercial embodiment as “eTwin^{SM},” are dynamically integrated into travel planning and booking, navigation and mapping, storage, modification and correction of route information processes.

The Journey Wizard^{SM} embodiment also includes user and expert generated content and integrated community features, such as sharing of trips for the purpose of multiple individuals “adopting” and subsequently customizing the same trip or linking together what are referred to as “TripTiles^{SM}”, and trip logs, photos and video capable of being shared across a broad range of Internet social networking sites.

The tools underlying the system of the present invention can be used for much more than road trip planning, so the term Journey Planning is much more accurate a description than the current Uniform Resource Locator (URL) www.roadtripwizard.com or planned business to consumer brand, RoadEscapes.com. The toolset has been architected in such a way, that it could easily be configured for marketing purposes as, by way of example, and without limitation, BikerEscapes, with an assumed “HOW” or mode of transportation as a motorcycle; or the “WHO” you are traveling with could be set to family automatically for a trip portal designated “FamilyEscapes;” for pet owners, it could be tailored to their needs and automatically be set to have pets along in the WHO portal designated “PetEscapes.” The flexibility of approach of the method of the invention is limitless, as well as being capable of extremely specific implementation, such as, for example, “SpelunkingEscapes,” for those who love to explore caves. All of the eTwins in this case would be set to include not only spelunking, but other activities and points of interest categories that are common to individuals who enjoy this activity.

Although the initial commercialization of this technology is focused on road trip planning, its effectiveness as a tool is not limited to this market.

The commercial embodiment of the present invention is not simply a roadtrip planning tool, but truly allows the planning of any type of journey of any length, including trips comprising multiple modes of transportation. It has demonstrable utility when you fly to your destination and need to plot out the remainder of the journey, when you rent a car or get a taxi or are picked up by a friend or colleague, as it is for finding things to do around town in your home town or things to do on a weekend or an overnight trip.

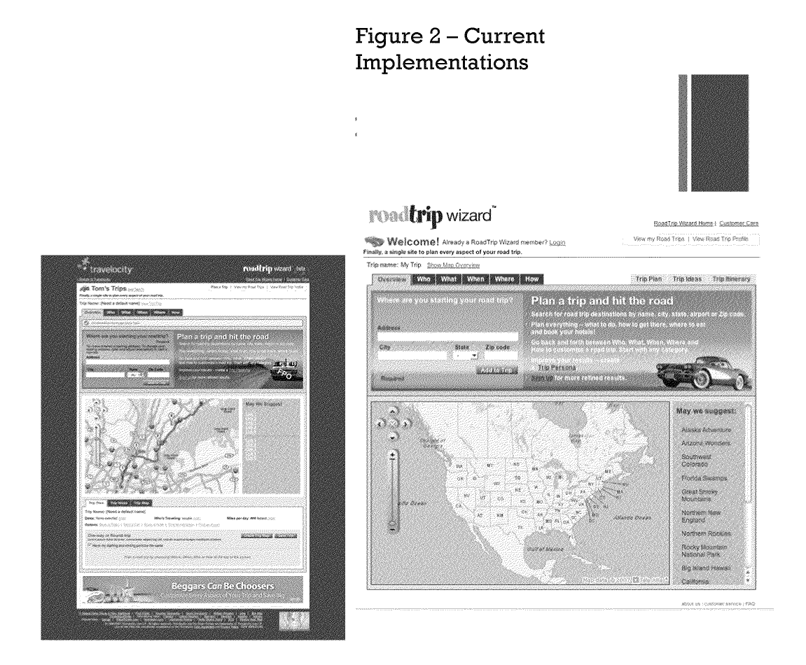

The consumer view of the journey planning tool, implemented in the commercial embodiment as the RoadTrip Wizard (see FIG. 2) includes both a “build it from scratch” trip planning tool, and pre-built, stored trips that can be “adopted” as is or modified to fit a user's specific needs or preferences.

In a variation of the commercial embodiment of the system of the invention, third-party services, accessed through the Internet, can offer both the “build it from scratch” tool within their own system(s) and website(s) by linking from their capability to our system. This private label capability is branded as Journey Wizard^{SM}, and they can also integrate what is referred to as an “Adopt-A-Trip™” capability into their narrative/editorial content pages, linked to previously stored trips within the tool designated as Journey Wizard^{SM}. By way of contrast, to achieve this using methods found in the prior art would require a manual business process. However, the system of the invention can be adapted, through implementation of appropriate software-based tools, to automatically extract points of interest from proper names mentioned in an editorial article and auto-create a trip from those points of interest, categorize the trip by genre and recommended eTwin profiles, then send the hyperlinked widget, which is electronically linked to the resulting trip URL, plus a graphical representation of the route map to the Adopt-A-Trip customer. In turn, as their users or subscribers read the feature story and click on the widget on the third-party site where the originating content is found, or the stored trip is also syndicated to subscribers and/or users of the primary Internet site implementing the practice of the present invention.

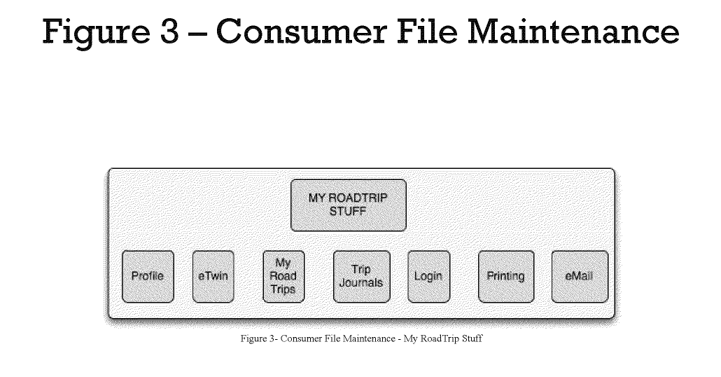

FIG. 3 shows the set of applets that allow the consumer to manage their profile, their eTwins, their trips, their trip journals, login, printing and emailing of their Trip Records.

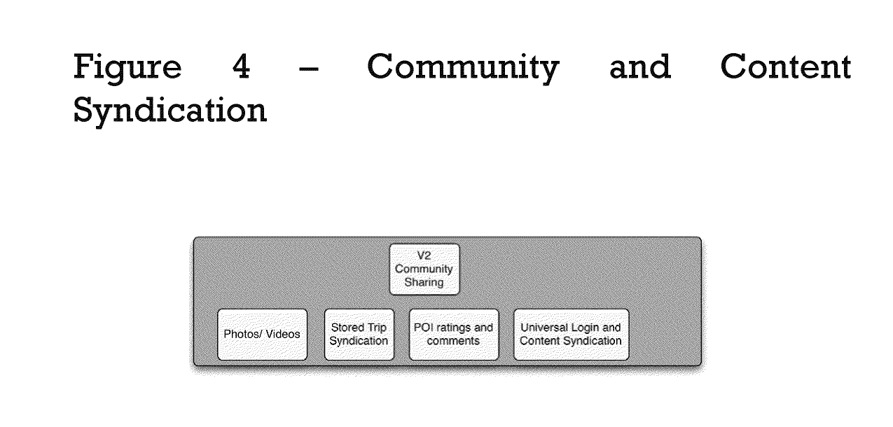

FIG. 4 shows the various components of the Community and Content Syndication features of system of the invention, as implemented in the commercial product. This includes the sharing features of the system (including sharing and syndication of photos, trip journals, videos and stored trips), user-generated content as it relates to points of interest (POIs) and comments/opinions. This module also includes an applet that manages universal login between social networks, to facilitate content syndication between various systems, such as MySpace, FaceBook, YouTube, etc. without requiring a separate login process each time. This portlet will manage security governing syndication of the sharing of data to and from the system, including defining sharing “groups” for various types of activities.

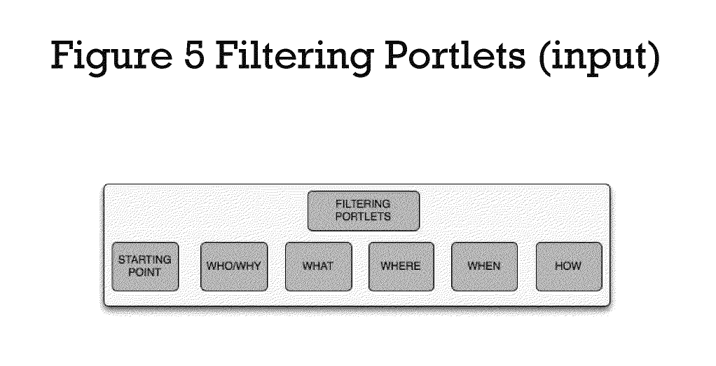

FIG. 5 depicts the input portlets that the consumer uses to allow the system to do its filtering tasks when displaying results.

In the practice of the method of the present invention, the consumer enters their geographic starting point (which can be home or the point where they are meeting up with others or where they are landing in an air-focused trip). If the user is logged in, this is autofilled with their city/state or province at minimum and their full street address if they have specified it in their profile. The system then orients the map to that point and adds that point of interest to the trip. The consumer can then proceed through any or all of the remaining portlets, which do not have to be executed in any particular order. The results from any given portlet are filtered by whatever other portlet has already been executed. For instance, if the user starts with WHO/WHY and selects the family eTwin and checks that they are traveling with their dog, the content displayed in the results for WHAT they want to do along with way will be filtered by the appropriate age group for the children (based on previously-stored user data profiles) and for traveling with a pet. Fuzzy logic is used to filter points of interest and events that are not suitable, recommended or “friendly” to the specified age groups based on pre-determined attributes appropriate to a given venue type.

Likewise, if a consumer first begins with WHERE they are going, anything that they want to do and see will be filtered by that geographic perspective. If they specify WHEN they are traveling and state that they intend to take a four-day trip in the Winter, but ask for Dude Ranches, Dude Ranches in Montana will be screened out as not being open or appropriate to winter travel. If they select HOW first and indicate that they are traveling by RV and want to go to a National Park in the Southeast, the system will filter out those parks that do not have parking and power facilities for RVs and those other attributes that contribute to the fuzzy logic supporting the system-generated “RV friendly” or “Motorcycle friendly” distinctions.

For those items that have a sponsor/advertiser, there will also be a COUPON link (a button or icon depending on where in the planning process the user may be), where the consumer can indicate specifically that they would like a coupon to be included in their trip itinerary and for items that can be directly booked or reserved on the site. In addition, where appropriate or possible, there can be an indication of the normal price range for the item and a link to take the user to the booking engine. Such linked booking capacity function is not limited to booking of accommodations and activities and events, but can extend to any item or activity that can be pre-reserved and/or pre-paid with issuance of a confirmation and/or voucher or ticket. At any point in the trip planning process the user can also book air tickets, rent a car, book accommodations or find attractions and entertainment along the route of their trip within a corridor of up to 75 miles. This search from the route can be changed by day, as one day the consumer may be in a hurry and another day have lots of time to look at things along the way. In fact, this feature, coupled with the driving style of “no freeways” would take the consumer along the byways and hiways versus the freeway system. This corridor search, coupled with driving style designated in the HOW portlet and in the eTwin, is a novel feature of the invention.

In the practice of the method of the invention, once the user has created a login and a basic profile, the trip plan is then stored and can be communicated electronically to a friend or family member. If they did not create an eTwin before starting trip planning, or if they used one of the pre-defined eTwins, they will have the opportunity to save their preferences and create a unique eTwin based on their selections, or they may override the selections in the eTwin that was originally selected or provided. It is not necessary to login to simple build a trip or produce a route, only to save the trip and update the eTwin associated with the trip.

The product is designed to also allow the system to embed targeted coupons and offers into the Trip Itinerary document, allowing advertisers very specific point of sale/point of use opportunities to reach consumers. As an example, if a user is traveling to Montauk, N.Y. for a business trip, the system of the invention can allow restaurants or other service providers within a specified radius of the destination or route that fit the consumer's business trip persona to present offers in the form of coupons in the final “Trip Plan” generated by the system. Also, any point of interest in the database can have a coupon pre-attached that the consumer can self-select to include in their itinerary. These coupons can be dynamically updated by the provider by electronic links to the database underlying the system of the invention. If the coupon item is “bookable”, the user will also see a price range associated with the product or service offered through the coupon. If the user selects a link for “Check rates and book,” the system will take the consumer to the booking engine, which engine, by way of example, can be powered by existing commercial Internet services such as World Choice Travel, a division of Travelocity.

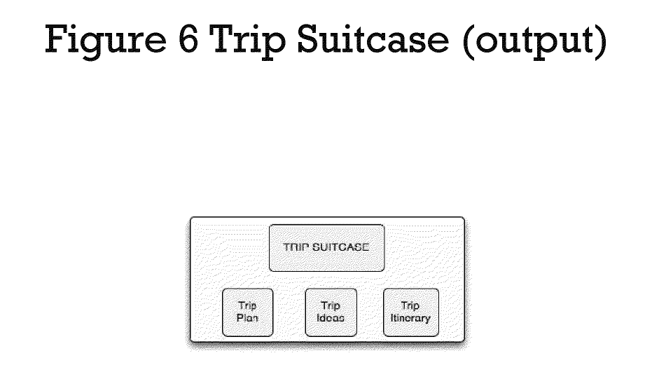

FIG. 6 illustrates the output from a typical trip planning process, which output is referred to as the “Trip Suitcase” in the commercial embodiment. It includes the trip plan, or the Points of Interest (“POI's”) in the trip which will be included in the turn by turn directions, the “Trip Ideas” that, while noted and mapped, are not included in the turn by turn directions or route, and the “Trip Itinerary” that is a reflection of the combination of the Trip Plan, the Trip Ideas, the driving style of the consumer (as recorded in the user's stored profile), which style determines where the day breaks naturally occur in the trip, and the turn-by-turn directions and maps for each day of the trip. This feature is also used to store, e-mail and print the trip, as well as to save the eTwin if the user was not logged in before starting the process.

Using the tools mentioned in FIGS. 3-6, the system of the present invention is able to offer both consumer clients and business customers to use the following components of the system, coupled with the underlying content database and advice engine:

Trip Planner—Build from scratch trips In this instance the user begins from a starting point on the Overview tab of the Journey Wizard and adds points of interest filtered by WHO they are traveling with, WHAT they want to do, WHEN they want to travel, WHERE they want to go and HOW they are getting there. They can use any of these functions in any order and the results that are displayed are reflective of the application of the various filters invoked. In this way, the method of the invention achieves an expansion of the extremely limited search and buying metaphors common in the prior art, as well as delivering situationally relevant, intent-based filtered content in the form of results lists that are ordered by listing the highest recommendations, commercially known as Editors picks, expert picks or branded concierge picks, such as the Hyatt Tampa's Concierge, with a picture and first name of the concierge that put together the recommendations and stored trips.

As the consumer displays search results, each point of interest (which is geocoded in the underlying content system) is plotted on the map and then the user can add items to their Trip Plan (which get included in turn-by-turn directions), or simply add them to their Trip Ideas page (where they are mapped, but not routed), and can produce a complete Trip Itinerary, including the trip plan and ideas, items, and turn by turn directions. The system displays results based on the keywords or categories selected and does not require the user to search within a single category. For instance, they can search for Brew Pubs and Indian Restaurants without having to wade through other types of Places to Eat or drink. Or they can do a natural language text search for chocolate and see towns named Chocolate, intermingled with stores that sell chocolate or restaurants and bistros or deli shops that specialize in chocolate drinks and/or desserts.

Adopt-a-Trip™ In this alternate implementation of the method of the invention, the consumer adopts a trip that is either listed on the site or on one of a linked, third-party site, which can be referred to in traditional offline media. The user can then customize it to include their starting point and modify anything in the trip to suit their specific needs or interests. Due to the sophistication of the eTwin and the Advice Engine, the results will be filtered by the eTwin selected for a given trip, as well as those modifications made at transaction time.

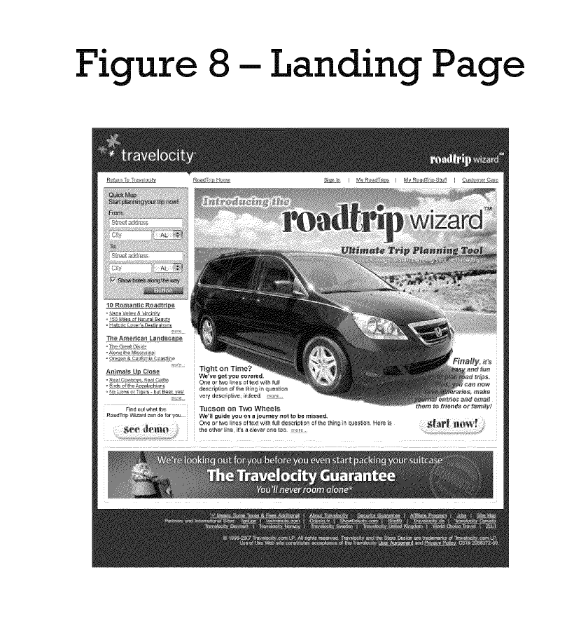

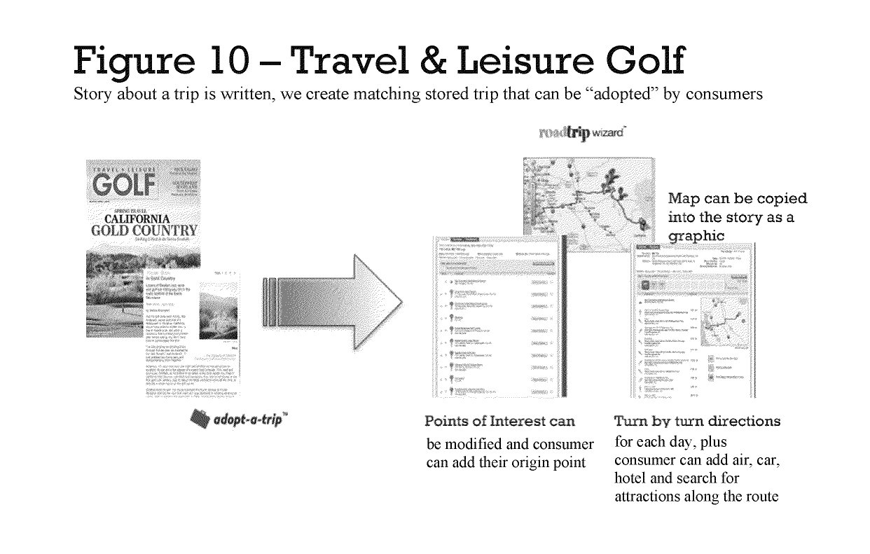

These stored trips are listed in the “May we suggest” box in FIG. 2, but could easily be included on a separate landing page with editorial text, as shown in FIG. 8, either within the primary site (organized by genre or by destination or any other method of manual segregation), or they could be on a linked, third-party site, or even in an offline publication such as a magazine, a newspaper or a television or radio show talking about a place or an experience. In the offline instance, the publication or sponsoring third party would point the consumer to the third-party site and a link to “adopt” the trip. Alternatively, the print content could parenthetically provide alphanumeric codes that, when input into an appropriate place on either the primary site or a third-party site, calls up a stored trip that the user can adopt as a starting point for trip planning. See FIG. 10 for a diagram of how this would work in practice, using American Express Travel and Leisure Golf magazine as an example.

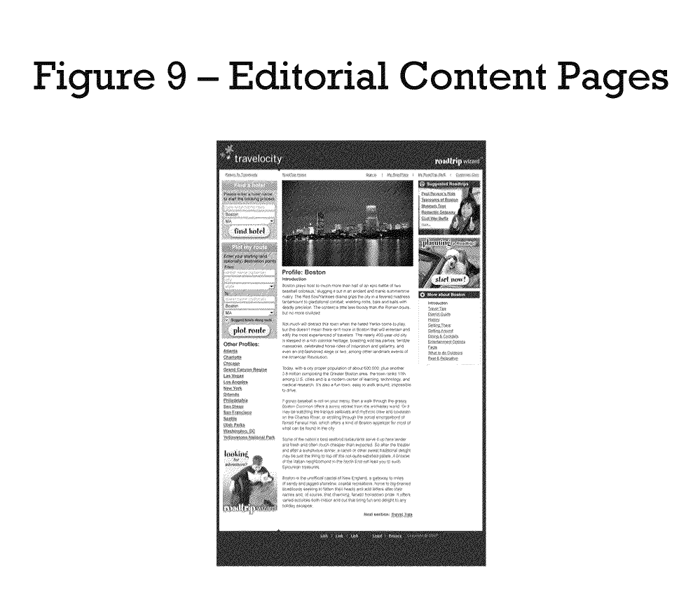

The process of building a stored trip can be a manual one done through the efforts of the operators of the system of the invention, logged into the same consumer tool with a specially enabled, secure SuperUser login. Alternatively, an automated application that accepts an electronic version of editorial content from a linked third-party (see FIG. 9) can automatically generate the stored trip, along with an audit report that would include points of interest that need to be added through additional tools associated with the system. Once the trip is properly classified by genre and eTwin type, and “approved” electronically, the marked-up story and an embedded link to the trip, possibly along with appropriate branding indicators, along with a graphical image of the route map, will be sent electronically to the third party site or site administrators.

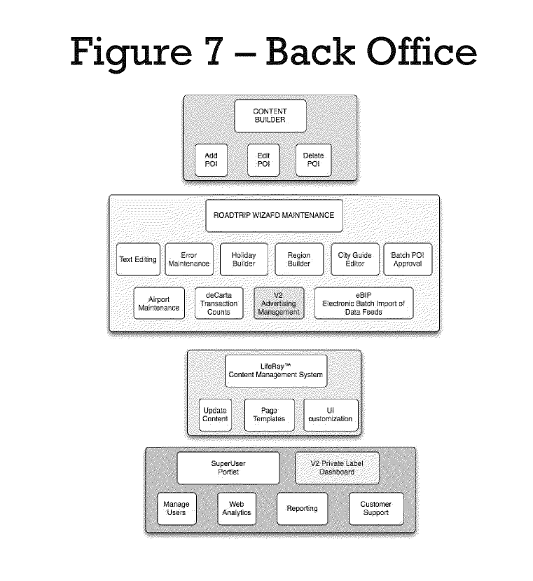

The system of the invention utilizes a number of “back office” applications, as shown in FIG. 7, that support and are used to maintain various components of the journey planning tools.

Content Builder is a tool used to add, edit and delete points of interest. It works hand in hand with one of the maintenance applications known as eBIP™, or electronic batch import of data feeds. Once the content has been imported or manually created, the system can apply a number of attributes and add additional data to each point of interest. There is also a work flow tool that manages the approval process and facilitates batch approval of points of interest.

Additional maintenance tools govern how text and error messages display, as well as building out parameters for how the system operates. This includes the holiday and region building tools. Holiday builder is used in conjunction with the calendar and events tools. The calendar allows the user to browse for events that are date-specific or season-specific and to filter out those that do not fit into the various input portlet categories selected. The holiday function will further allow the user to see their own holidays (if international or of a particular religious persuasion as set in the Profile) and to see the holidays of the geographic region that they are visiting.

The region builder allows the system of the invention to pre-define regions, such as a “tri-state area” for a destination marketing organization managing the tourism assets of three adjacent states or for the “Appalachian trail,” or “Wine Country” by way of examples. The system also provides a tool that allows editing of imported city guides, airport codes imported from external sources and also tracking of transactions for a linked mapping vendor.

Alternately, the system can provide an application that includes an advertising management tool that allows the system to interface with our advertising provider(s) to manage the display of various ads, both external to the specific graphical content generated by the functioning of the system (e.g., in borders outside the application portlet) and within the application, such as rotating different car types for an automobile manufacturer sponsor through a landing page window (a classic Corvette in FIG. 2).

As outlined in FIG. 7, the system of the invention also comprises a content management component (based on the Open Source LifeRay™ CMS) that allows the system to update content, update page templates and customize the user interface using cascading style sheets.

The last back office component of the system is designated the SuperUser portlet, which component includes a Private Label Dashboard configuration tool. This enables the system to provide third-party clients and their affiliates with what appears to the external user to be their client's own unique implementation of the system but which, in reality, uses Service Oriented Architecture to allow the primary system to modify not only the way the system looks, but from what source the system draws content, community, inventory and mapping interfaces. It also allows the system to toggle certain content categories on and off for a family of users of the system (e.g., a parent and its affiliates).

Another component of the SuperUser portlet is the ability to manage users of the administrative tools and support features, including access of web analytics, reporting, customer support, system eTwin collection creation and stored trip creation. It manages not only the journey planning toolset but also the ContentBuilder and maintenance applications.

In general, the system of the present invention comprises a user-selected, multi-dimensional and multi-variable profile, used by an intelligent advice engine tool that drives situationally relevant recommendations. This is necessary, as computer applications cannot predict with any certainty a person's intent in a search as it relates to planning a journey of any sort as that prediction would be based on objective trip criteria such as starting and ending points, duration, time of year, and the like. This is because preferences change based on the following elements, as depicted in Table 1, below (or any combination of these).

TABLE 1

| Element | Impact to Preferences | Differentiation |
|---|---|---|
| WHO | Who you are traveling with | While some sites provide some |
| | and why shape what you | ideas for family travel, or |
| | are looking to include in | romantic travel or even |
| | your trip and even where | ecotourism, they generally |
| | you are going if you are | pre-populate the choices |
| | indifferent at the outset | versus allowing you to make |
| | of planning. | selections and then filter |
| | | the results based on those |
| | | choices. |
| WHAT | What you [and your group] | We filter the results from |
| | like to do given a choice | the various categories of |
| | changes based on who you | what you would like to do on |
| | are with, when you want to | your trip. In addition to |
| | go and even how you are | standard categories included |
| | traveling. It also changes | on other travel, destination |
| | based on where you will be, | and genre sites, we include |
| | as you may love Thai food, | totally unique categories, |
| | but in Greenfield, Indiana, | such as shopping and things |
| | that just may not be an | you need along the way. A |
| | option. | complete list of the 5 |
| | | million plus points of |
| | | interest are included as |
| | | Attachment A to this |
| | | application. |
| WHEN | When you are traveling can | Most other travel and mapping |
| | impact your choices as | sites limit the travel dates |
| | well. The Journey Wizard | to specific departure and |
| | provides for departure and | return dates and this is |
| | return dates like most | often a requirement in order |
| | travel systems, but it also | to get any information, so |
| | allows you to specify the | often bogus dates are |
| | number of days and the | entered. |
| | season for your trip. | The date is not a mandatory |
| | | element of the system until |
| | | you are ready to confirm |
| | | lodging or another bookable, |
| | | date oriented item such as |
| | | buying an event or |
| | | attractions ticket. |
| WHERE | Where you are going often | Most travel systems utilize |
| | has a tremendous impact on | airport codes/names or major |
| | your choices of things to | city drop down or pull down |
| | do or even when to go. | lists for the “where” element |
| | | of a trip. We include |
| | | address and/or city, state or |
| | | zip or just selection of a |
| | | region. This is not a |
| | | mandatory part of building a |
| | | trip, although is still the |
| | | most common way to start |
| | | planning. |
| HOW | If you are traveling by | Journey Wizard combines |
| | car, versus taxi, RV, | choice of vehicle/mode of |
| | motorcycle or on foot, your | transportation with “GPS |
| | preferences will likely be | style” driving preferences, |
| | different. And if you are | such as “avoid freeways” and |
| | flying, you may still be | how many miles per day you |
| | renting a car or taking a | wish to drive. |
| | taxi or having a friend | |
| | drive you. | |

The tool component of this embodiment of the invention interactively maps results and plots events and trip elements simultaneously and graphically on a map, as well as into a trip plan, a list of trip ideas and a specific itinerary that contains turn-by-turn route plans, day maps and driving directions. The product roadmap also includes the use of an interactive calendar that is integrated into the users' desktop calendar by way of standard calendar update mechanisms, such as iCal and vCal handoff files, as well as allowing the calendar to be used as a search tool, in addition to a tool for display of trip elements. Lastly, the calendar tool may preferably have an integrated group “date finder”, where a trip organizer can suggest a certain range of dates or date ranges and submit it via a t-vite™ or trip invitation to individuals that they would like to join them on the trip. This can be used in conjunction with both stored trips and TripTiles.

That route plan can then be distributed electronically, either wirelessly or via a hard device, such as an SD card or a USB flash memory device to a personal navigation device to facilitate personal travel routing on a Global Positioning Satellite (GPS) device. While a preferred solution is focused on the road traveler, the Journey Wizard tool of the commercial embodiment of the invention can also be used to plan a trip wherever a user travels, where it is possible to lay out various day trips that can be done within a 150-mile radius of the user's destination or route or an adjustable corridor of up to 75 miles along their planned route. The user can also insert city, town and village names and any point of interest or address as “way points” to force a route to go through certain states, cities or specific points of interest. This would allow an individual from Tampa to adopt a trip to Yellowstone and indicate that they want to visit a friend in Ada, Okla., as well as to return through St. Louis in order to see the Arch and the Lindberg museum. This is a novel feature of the invention, when coupled with the driving style preferences and the use of the eTwin to filter attractions, etc. along the way.

In general, utilizing resources in the prior art, the road traveler needs several sources in order to plan a road trip. They must first map out their intended route, then attempt to estimate how far they will drive each day and where they will stay. Often they need to look at a wide range of different Internet sites to determine what they can do along the way or even consult various hard-copy guidebooks. This can take the planner many hours. The users of the current invention are spending on average 13 minutes and 38 seconds to plan a trip using the commercially-available Journey Wizard.

When a consumer is using online resources, whether on a mapping site or a travel site, the current buying metaphor is firmly and historically grounded in prompting where and when the traveler is traveling. This does not provide any flexibility for the individual that just knows that they want—a long weekend sometime in the fall, or they want to go on a sisters' getaway cabin, or that they want to go wine tasting somewhere and are tired of Napa Valley. Or they are going to Savannah, Ga. and love chocolate and want to find a chocolate store.

Lastly, although content sources are getting richer and richer for planning, they are also getting more and more fragmented and less and less relevant. On-line travel companies, mapping providers and media companies alike, are left to fend for themselves in aggregating the content they need for their site and, due to legacy system limitations, are restricted to certain categories of content, versus a broad, natural language based search system that allows for category across virtually every category of consumer points of interest and commerce in a single search results display, without being cluttered with the types of results that are typical to a general search engine. For example, the invention produces for Savannah, Ga. six results in a search for Chocolate. Conversely, Google produces 384,000 results, many of which are totally irrelevant and not even located in Savannah or even the state of Georgia. This location-based, filtered content search is what is truly novel and simply not available in the prior art.

Additionally, the travel industry has focused nearly exclusively on major cities for business travelers and on top vacation destinations, which limits their content dramatically. Also, although they do have hotels in secondary cities and small towns, they do not have the types of venues needed by the everyday traveler, nor do they have the tools to pull together a trip to those secondary cities and small towns. With the exception of certain representatives in the American Automobile Association clubs that service its AAA members, the professional travel agent has not been able to assist travelers with travel by car. The industry at large, including AAA, has not been able to assist with travel to “off the beaten path” attractions, such as visiting the Regal Boat Factory in Orlando versus going to a theme park or adequately understand how to plan travel to secondary destinations for the mundane events of life—birth, death, graduation, family reunion, tournaments, competitions, recitals, etc, etc., based solely on the address of a church, a theatre or university arena.

This is tantamount to what happened over the last 40 years in the restaurant industry. Forty years ago, if a consumer wanted to go out to eat, the consumer went to a restaurant, the food was served to you on a plate and that was the norm. Over time, the pace of life changed and demand for fast food grew. Now food moved from the plate to a bag. Certain tools were needed to make this efficient, witness the counter, stations for bagging certain components of food and special cups, bags and trays for carry out. The food didn't change for the most part. The product was there, the tools just had to change to extract the product to the changing audience. Years later, carry out was not fast enough. People didn't want to get out of their cars. So some fast food restaurants punched holes in the wall, installed cash registers by the drive-through window and eventually utilized headsets and remote ordering technology. Again the product did not change. And once fast food restaurants began to reach this market, their upscale competitors responded with the addition of phone or fax in carryout where they bring the food out to the car, even absent the drive through metaphor.

The travel industry is at a crossroads, as it has relied for nearly 30 years on the technology provided to them in the late 70s by the airlines. The underlying technology for the industry is still very airline traveler-focused, even though the systems used by the industry also include hotels, car rentals, cruises, etc. The products are relevant, but the tools are totally inadequate to handle the multi-destination traveler, who need maps and driving directions and needs to find everyday places such as stores, banks, the laundromat, churches and hospitals. It is time to punch the metaphorical hole in the wall with the introduction of this invention as an underlying, enabling technology to facilitate the industry standard distribution channels to service the broader market. Today only $200 billion in travel spending is planned and booked electronically out of a $1.4 trillion leisure US domestic travel market. Eighty-eight percent of all travel is by car in the US, so it is clear that the tools are required.

There is no single provider today that is focusing on providing an underlying, enabling technology that allows intelligent use of the available content and a new way to market to the traveler that would increase the ability to convert that traveler from a planner to a buyer or to monetize their visit to a site or an agency through the use of advertising and sponsorship as a new revenue stream and business model for a totally commoditized industry.

The reason behind the stagnation in the development of better planning and purchasing tools stems back to the foundation for the automation of the travel industry, the global distribution systems (Sabre, Amadeus, Galileo and Worldspan). These systems began as airline reservation systems and for nearly 30 years have provided the basis for offline travel planning by professional travel agents and, with the advent of the Internet in the mid-90's, as a commercial tool, they have also “powered” the online travel planning tools. For instance, Travelport's Worldspan “powers” the booking engine behind Expedia, Priceline and Orbitz and Sabre “powers” Travelocity's booking capabilities. Due to their airline system heritage, these systems required the buyer to state where and when they are going before any type of travel product information could be delivered (e.g. hotel, activities, destination information). Yet, in the real world, people shop based on who they are traveling with, what they want to do and how they are traveling and, in many cases, when and where are secondary. Search is impersonal at best and generic at worst.

Most systems segregate travel preferences by business and leisure travel and assume that under both of those circumstances that you always make the same choices. In reality a business traveler makes different decisions if a client is paying for a trip, versus when the company is absorbing the cost or perhaps makes different decisions if they are on a sales trip where they can entertain clients versus a training trip where they have more limited spending authority. On a leisure trip, there are many different drivers—the season, the purpose of trip and what type of vehicle you are taking to get you there and who is with you.

The point is that travelers do not know a priori that they want to go to, for instance, Chicago. They first have a reason to go to Chicago—visiting friends, attending an event, a special museum exhibit—and therefore they have to go Chicago. Existing travel systems don't work that way.

Also, if you have items that you “might” want to do on a trip, there is currently no way other than printing out individual web pages or taking along a guide book to have that information with you on your trip.

Additionally, once in their vehicle, since the inception of such devices, personal navigation and GPS devices treat everyone the same and do not have an ability to segregate recommendations for routes and points of interest based on the situational recommendation notion outlined above. If a driver is alone, they may want to see ethnic restaurants, but if with the family may only want to see fast food or if a couple is traveling alone they may want to see all the antique shops and if with the family want to be aware of an aquarium or water park or just a municipal pool or park along the way or at the destination. Additionally, today there is not a way to plan offline in your home or office and translate that plan into your device in the vehicle. You are left with only the option to re-enter your starting points and destination(s) individually and would have no way to highlight the kinds of things you want to see on this trip with the people you are traveling with at this specific time, filtering out all non-relevant POI's.

A logical extension of this intelligence fits perfectly into the automobile/vehicle utilization of this product. In addition to the use for navigation of a planned trip, the eTwin can be used to tailor the music that you listen to for various reasons and when certain people are in the car; it can be used to filter news or information accessed via the internet in the car; it can be used to set the wallpaper on the screen of the in-dash computer and to filter points of interest shown on a GPS even when a trip isn't pre-planned. It can also be used to filter the entertainment choices of various people in a car, all based on a pre-defined eTwin covering each circumstance and set of preferences.

The Journey Wizard^{SM}, the content database and its Advice Engine work hand-in-hand to produce customized recommendations for the traveler. They do so with a unique planning and buying metaphor (e.g. dialogue with the consumer in the form of a simplified user experience) that allows the consumer to begin by defining their “persona” for the trip, known commercially as the eTwin for the trip, each of which comes with a robust collection of customizable personal and trip preferences.

The Journey Wizard^{SM} and Advice Engine are akin to “fuzzy logic” systems in that evaluate data based on travel experiential factors that mirror an individual's internal travel planning and thought processes prior to settling on a trip. These preference settings then cause the Advice Engine to filter the content to match the request.

The Journey Wizard™ and its Advice Engine represent the first time an on-line travel service has sought to emulate the manner in which people actually plan travel. The degree to which the Advice Engine participates in the travel planning process is completely under the control of the user and can be overridden at will each time a trip is planned, edited or cloned.

Once the user selects elements for their trip, these are ranked and the results shown. Alternatively, a graphical “Fit-O-Meter” can be used that illustrates graphically how close a match or fit the results are to the request. This is a necessary part of the methodology of the system, as a user can look at unfiltered results as well as the filtered results and perhaps choose something totally inappropriate (e.g. selecting that they are traveling with a pet and then picking a hotel that does not allow pets). In that event, the Fit-O-Meter will show a “So-So” fit. This feedback loop has heretofore been unavailable, except through a human interface with a travel agent or call center agent. This same metaphor will be used to rank the trips after the consumer has traveled.

Additionally, the system of the invention can function as “underlying technology” that can be used by other businesses to power their travel-related systems, much in the same way that the Intel chip powers a PC or in the same way that many companies embed the Google search bar and advertising into their sites. By using the invention via web services and/or service oriented architecture tools such as an applications programming interface (API), the Value Added Reseller or Original Equipment Manufacturer customers of the Journey Wizard can use their own look and feel and implement component parts of the invention, such as mapping and driving directions layered with the eTwin, versus simply private labeling the user experience of the full journey planning tool.

The results of a travel planning and purchase session are presented in a graphical manner that integrates mapping, driving directions, a calendar and trip itinerary, all based on a collection of explicit requirements selected directly by the traveler by travel product or indirectly by stated eTwin preferences, merged with implicit requirements provided by our Advice Engine and a proprietary weighting system that considers experiential travel parameters, rather than simple point-to-point and date parameters.

To the company that integrates the system of the invention into their Web site, such as Travelocity's present implementation at www.travelocity.roadtripwizard.com, the present invention provides tools that offer a way to improve the conversion of planners to buyers by first increasing the “stickiness” of the site, which results in an improvement in the return rate of unique visitors to their site, reducing the cost of customer acquisition. Over time it should also result in an increasing conversion of visitors to a sale or to acquisition of a coupon that when redeemed produces incremental revenue. This is how many third-party partners generate revenue, so the product will be of great value to them from an economic perspective. For the value added reseller, such as a GPS or personal navigation system device manufacturer, the invention extends their capabilities and adds value to the services they are currently providing to their customer base without significant investment.

The Journey Wizard^{SM} and Advice Engine of the commercial embodiment of the invention include some component technologies that, taken in isolation, are already in use. This would include database modeling and filtering, basic mapping engine functionality, the ability to book travel components and view them on a map, user-defined preferences as they relate to product delivery and the ability to save a session for future reference or further work.

The Journey Wizard^{SM} encompasses a data model and filtering matrix with entirely novel parameters as they relate to the travel planning and purchase process, as well as offering multi-tier filtering capabilities that are designed to work within an Advice Engine environment. Travel database applications to date are limited by applying binary “on” or “off” and “yes” and “no” attributes to products, activities or points of interest. The Advice Engine of the system of the invention further characterizes products and points of interest as “maybe,” “worth considering,” “we know you've selected this, but it just doesn't fit,” and “this is just a little farther than you want to travel, but we think it's worth the effort.”

These attributes are assigned to products and points of interest through a combination of basic binary database filtering mechanisms, as well as assigned attributes from internal staff and external contributors and users through feedback and ratings. It is a fluid and dynamic process, as it should be. In the real world, things change.

The system of the invention is actually a platform with various toolsets that are used in concert with one another to facilitate the creation of various Trip Wizards, as they are referred to. The first portion of the system is the new buying process or buying “metaphor”. The second is the tool that is used to create the multi-dimensional, multi-faceted profile and eTwin Collections. The system uses this same tool to create a stored persona or eTwin that is the foundation for creating unique versions of the Wizard tool (e.g., Senior Travel Wizard, Golf Travel Wizard, Winter Sports Enthusiast Wizard, etc.).

The recommendations engine is an important element of the system of the invention, as it uses the output from the Profile/Persona creation tool to generate unique recommendations for a trip.

The other two components of the system also work hand-in-hand. The private label dashboard is a configurator tool that allows customization of the platform in hours, not days or weeks, for a new customer. It manages the unique content, inventory and business rules for a new private label customer.

The content builder is the final component, providing a way for the system to not only import content from external sources, but also to “tag” content with various and novel attributes that allow the eTwin and the Recommendations Engine to work hand in hand, both more efficiently and more effectively. The invention has more than one hundred unique and novel attributes, which vary by type of venue/event.

The content builder organizes static content, such as points of interest and destination information, as well as variable, date sensitive content, such as inventory and events. It also allows the system to input user-generated content, whether from a social networking tool (embedded into the system) or from an external source.

As stated prior, the Journey Wizard™ and Advice Engine represents a unique collection of powerful tools users can bring to bear on the trip planning and product purchase process. The consumer begins with the ability to select the starting point in the planning process from WHO you are traveling with, WHAT you want to do at your destination(s), WHEN you are traveling, WHERE you want to go and HOW you will travel. Then, taking those selections, coming up with a travel plan and potentially booking all or some of those elements.

Starting point of the journey planning process The user can fill out the Starting Point screen or can move directly to WHO, WHAT, WHEN, WHERE or HOW and can complete those in ANY order. If the user skips this screen, they may come back at any point in time.

Once the starting point has been entered and the user has selected Add to Trip, the point of interest represented by the address (or just city and state) will be plotted on the map and the instructional screen to the right of the input box will change. Alternatively, the user will be able of the invention to utilize a subset of the invention, such as producing simple point to point directions or map a single POI by adding the additional addresses in the first instance or just entering a single point of interest name or address in a simpler UI than the full journey planning tool.

As the user moves through the selection process by using the Who/What/When/Where/How/Why elements, the results are displayed on three persistent elements of the design—the Map, the Trip Plan and, for events and items with a date associated with them (such as a hotel or activities booking), these will be displayed on a calendar. The calendar metaphor can also be used to select dates, in addition to being a display mechanism. Lastly, the items will show on the Trip Itinerary once the trip has been plotted.

The WHO portlet allows you to pick an existing or a stored, system-generated eTwin that shapes the balance of the shopping/planning process. For example, a user might have a stored eTwin built for family trips in the summer and one for winter, or the user might have one for traveling solo on a Harley-Davidson motorcycle, or for traveling as a couple. A user might build one for outdoor-focused trips, or for those where the user travels with extended family or friends. The use of the “eTwin” allows the user to bypass, by means of the stored data that comprise each eTwin, a lot of the questions that help the system narrow the search later on, making the process even more efficient.

Within the WHO portlet, the user indicates the number of people traveling and whether there are children traveling as part of the group. Not only do we keep track of the number of children, but the age ranges, as a trip is totally different if you are trying to accommodate a four-year-old versus traveling with teenagers.

The system allows the user to specify a lodging budget, an activity level, whether the user prefers mostly inside or outside activities, and whether the user generally like mainstream suggestions or want to try things off the beaten path. Preferences are stored by age group, as well as being filtered by fuzzy logic associated with being “recommended”, “suitable” and “friendly” for various groupings by genre, gender and age.

The system captures the user's travel restrictions (pets, handicaps) and the reasons for traveling (romance, education, ecotourism, history, culture/arts and relaxation).

Once the settings are correct, the update can UPDATE the trip with the new settings. Any subsequent searches will yield results that match the settings.

The WHAT portlet is where the power of the Journey Wizard is displayed. Depending on whether the user has already selected where and when they are going or with whom they are going, or how they are going to get there, the WHAT choices are filtered by that information.

A user can begin by stating the name of a place or event that wish to visit, such as the Dali Museum. Even if the user is not sure where it is, they can enter the name in the search bar. The system will then list the search results, at which time the user can view the items on the map, or can display the description by clicking on the item name, or can add it to the trip or the ideas page. If a coupon is available or the user can pre-reserve or purchase an item, a booking indicator will be displayed with the price range of the tickets or accommodations.

If the user wants to specify the city, state or region to search nearby for points of interest, that can be entered here as well, or the user can use the Where tab.

The Trip Plan will reflect items the user has added to the Trip, including points of interest, events, addresses, cities, states or zip codes or regions. This is totally novel, especially when coupled with the search nearby for any point of interest near any other point of interest, and with the sophisticated eTwin filtering.

If the user has already added items to the Trip Plan, the user can use the Search Nearby feature on the Trip Plan screen to search for ANY point of interest or event close to any other point of interest or event within a 150 mile radius, defaulting to 20 miles.

the user simply selects Search Nearby and the system will take the user back to the WHAT portlet and mark the address as the item selected and then lets the user search for more items for the trip.

For example, if the user is searching for what is close to a selected hotel or to grandmas' house, the system allows the user to specify the radius up to 150 miles around that point of interest for the search. If the user has already plotted the route, it will search based on the buffer zone of up to 75 miles from that route. For instance if the user doesn't have a lot of spare time, the user might want to search within a 15 mile buffer of the route, versus a more leisurely trip where the user might be willing to go 90 miles off the chosen route to see or do something special.

The content is organized into Places to Stay, Eat, Shop and Go and Things to Do and Events to Attend and Things you Need before you go and along the way. Within each category there are a plethora of sub-categories, and can also narrow the search by various “collections”, such as items geared for 0-5-year-olds or for seniors. This list varies by content category, as do the elements that make up “kid-friendly” for each age group. For example, for a restaurant, kid-friendly for 0-5 would mean that the restaurant has high chairs, crayons or some other kind of activities for kids, a kids menu and price list.

Once the system displays the filtered results, the user can then “search within a search” to narrow choices further. The user can then add an item to the trip plan or to the trip ideas list, and for bookable items, reserve and pre-pay for the item or get a coupon if one is offered.

In the user's profile an alternative approach that has been designed allows the user indicate how many items the user wants displayed in results lists and this can be overridden at the time of search as well.

The map is a persistent element of the RoadTrip Wizard system. As the user selects items to include on the trip, they will appear as both color coded numbered and branded icons on the map.

What—Advanced Search The advanced search allows the user to narrow the list by category or by collection or rating. This is useful if the user is a 5 star traveler and doesn't want to see everything from small motels to resorts.

What—Result When the user does the search, the user will only see those items that pertain to their preferences, either as stored in an eTwin or those selected at transaction time. So while other sites show the user everything there is to do in a given place, the system of the invention allows the user to see, as an example, all NASCAR tracks around the country and then to do an event search for just a given date range, or a season.

At any time the user can click on the icon on the map to display the details or can click on the name on the results list. Clicking on the icon will provide the user a list of additional resources (including the POI's own web site as a pay for click link, other web resources specific to that POI, such as ratings and history) that the user can access in a new frame. This is a useful element of the system, as it is extremely challenging to hold all information captive in a single content database and still produce reliable, accurate and timely data.

The Journey Wizard is unique in that it displays results from multiple categories in a single listing. For that reason, the POI icons are preferably color-coded. They may also contain branded icons, which is a planned revenue opportunity. The results are automatically filtered and sorted by relevance. For travel suppliers, this will be a welcome change from the price obsession of the current online travel sites, where everything is sorted by price.

The user can change the sorting to sort by price or by rating or name or they can ask for a totally unfiltered search if they want to see everything. All items in the results list can be mapped so the user can see the proximity to where they want to go before they commit

While most travel sites force the user to commit to a departure and return date, the Wizard allows a “fuzzier” search for what you can do in a five-day trip or what you can do in the Spring, as an example.

It can also be used for the traditional date range or even for a day trip if you want to use the product just to see what you can do close to home (the “one tank trips”) on a Saturday.

Once the user has selected the season or a particular date range, they can search for an event or they can add a trip log for a given date. So if the user wants a NASCAR race, they will only see those that fall within the dates that the user can actually go that meet the specified WHAT criteria, not seeing every possible event during those dates.

Where Like the fuzzy search for dates, the user doesn't always know the city where they are going. Sometimes the user just knows the point of interest they want to see (e.g., Hershey Chocolate Factory) or the user knows that they want to go to the desert southwest and don't want to be limited to having to specify Phoenix or Tucson as the destination.

The RoadTrip Wizard allows the user to be as broad or as narrow as they need to be and to plot out multiple destinations, which is common for a road trip. The user can enter the name of a place or event, put in an address, or just a city, state or zip or select a region from the list versus today's more common metaphor of specifying an airport code or name or pulling down or selecting from a limited list of destinations.

All other results will be filtered by this information.

How Portlet The How function is also an essential part of trip planning, as the user makes different choices if they are taking the family car, versus driving a BMW motorcycle, or if they are driving the family RV.

The user can also have a different trip plan if they fly to their initial destination and drive from there. And driving style matters as to how the system plots out the trip. If the user drives 100 miles per day it produces a different trip plan than if they are a road warrior that does at least 500 miles per day.

The Trip Sandbox The Trip Sandbox allows the user to “play” with various trip options until they get it just right. It shows WHO the user is traveling with, WHEN they are traveling and HOW. Any of these items can be edited at any time and stored in a new eTwin or modified in the original one.

It then shows the items the user has selected and allows them to reorder them at their discretion. The user can also search dynamically for items within a certain radius or proximity to any item on your trip plan.

Once the user is ready to plot the trip route, they can then go to the Itinerary tool.

The Itinerary The last part of the process is producing the user's route/itinerary and getting the map and the driving directions. This part of the application also allows the user to save, print, email or book air, car, hotel, activities or add a stopover to the route.

The Route Plan can also display a “fit-o-meter” that helps the user to see how well they did in assembling a plan that matches their preferences. Most trips will be an “excellent” fit if the user lets the Wizard do the selections. If the user does an unfiltered search, for instance, and pick a hotel that doesn't allow pets when the user has said they are traveling with a pet, then the results will be “so-so.”

Once the user is done with the trip, they can save it, print it, clone it or email it to someone. We also allow a new user to save their selections to create a profile and an eTwin to match those selections.

Compare Trips Capability In the product roadmap the system has included the ability to compare trips. From the user's filing cabinet (known as My RoadTrip Stuff), the user will be able to compare up to three trips side by side. This allows the user to look at various elements of each trip, as well as the “fit” of each one.

My RoadTrip Stuff The My RoadTrip Stuff function allows the user to create and modify their profile, to create and modify trip personas and to view, modify, clone, email and delete trips.

eTwin Collection and Recommendations Engine Working Together to Deliver Relevance

During the advice generation process, the data model and matrix search encompasses hundred of attributes and these, in turn, support thousands of scenarios. The only limit to the scenarios supported by the application is in the data that forms the underpinnings of the service, and that data model already provides for the easy addition of additional data, should the need arise.

The “eTwin” feature is where the user can build various trip personalities. Each one can be stored with a picture that the user can upload from their own system. The user could have a couple eTwin with a picture of the user and their spouse, or a Disney trip persona with a picture of the Magic Kingdom or a golf persona with a picture of the user with their favorite driver in hand. The users are limited only by their imagination.

The ability to generate personalized results that are intent-based and situationally relevant, we begin with the creation of a profile and eTwin Collection. The profile contains basic contact information, travel preferences (including home airport and frequent traveler program names and numbers) and personal information (including traveling with pets or with someone with special needs). The home airport is used to populate the airport in the booking engine for airline tickets. The frequent traveler information is used for hotel bookings. The information about pets and special needs are used to filter content that is relevant for people traveling with pets and people with special needs, such as a walking, hearing, seeing or speaking disability. Currently we only utilize the walking disability flag and we are indifferent to whether that implies the use of a wheelchair or crutches, bad knees or just low stamina. It is used to filter out those activities that require a lot of walking or standing, or those that are high activity.

The second element that drives personalization is the eTwin, or electronic twin. This allows the user to create very specific things about their preferences that change with circumstance, time of year or travel partners.

The system preferably has four basic eTwins stored for use:
Couple (the most common unit of travel);
Traveling Solo;
Family;
Group.

The system displays a list of eTwins that are active at any point in time. Each item in the eTwin Collection can have a picture uploaded to make it easier to remember why it was created, plus the name, the traveling companions in the record, the driving style and lodging budget. This may reflect overall trip budget, including fuel.

The eTwin has a picture that provides a graphical reminder of what it is about (e.g. a picture of the user's family skiing might accompany the Winter Family eTwin).

Within the eTwin, the user notes their traveling companions, the activity choices, including energy level, indoor and outdoor and mainstream versus off the beaten path (both totally unique to the Journey Wizard as content attributes). It also includes the driving style, lodging (and later the full trip) budget including fuel and the basic categories of interests. Then for each eTwin in the collection, the user can indicate the various categories for Places to Stay, Places to Eat, Places to Go, Things to Do, Events to Attend, Places to Shop and Things you Need (along the way or before you go). These selections then follow the eTwin when it is used for a trip.

To take one simple example, it is possible to create an eTwin record for the sight-impaired individual traveling with a service dog. There is no travel planning service available at present to satisfy the requirements of this kind of traveler. There is certainly no travel service available that will help this kind of traveler and their driving companion that will get from one place to another and make recommendations along the route for places to stay that accommodate pets or things to do that don't entail a lot of walking.

As another example, a group of friends, all retired, some with difficulties getting around, want to travel cross-country in an RV. The RoadTrip Wizard™ and Advice Engine will tailor a trip for those travelers, whether it be recommending hotels that have elevators and a pull-through drive way so they won't have to back up the RV, or attractions that will thrill without requiring long waits in long lines or stressful physical activity. This kind of functionality is unparalleled.

The RoadTrip Wizard™ offers a collection of tools, any one of which can be used as a starting point for trip planning, and they can be used in any combination, based on:
The persona (eTwin) of the traveler or travelers for this trip;
What does the traveler(s) want to do;
What does the traveler(s) want to see;
Where does the traveler(s) want to go;
Why is the traveler(s) traveling;
How much time the traveler(s) have;
How much the traveler(s) want to spend;
When the traveler(s) want to go;
What the traveler want to experience;
How is the traveler(s) getting there;
Where the traveler(s) want to stay.

The platform allows a road traveler to specify, for instance, that they are traveling for one week with two children under the age of five; that the parents would like the occasional romantic evening out; that they are naturally interested in activities during the day to amuse the children; that they would rather not travel more than 200 miles a day; that they would like to include a long weekend to save on vacation days; and that they have a specific budget.

The platform was built with the understanding that one person will have multiple eTwins, depending on when, why or who they are traveling with, for example:
As married but traveling alone;
As married and traveling with spouse;
Traveling with friends;
Traveling with spouse and children; or
Traveling with family and grandparents.

The eTwins mentioned above each have further subcategories, for example, traveling with spouse to:
Get from one place to another quickly;
See a show or attend an event;
Get away for rest and relaxation;
Winter travel versus summer travel; and/or
Take a long weekend for cultural enrichment and discovery.

Traveling with pets and children has long been a challenge. For instance, when traveling with a four-year-old and wanting an appropriate theme park, in Orlando clearly the Magic Kingdom offers the most for children of this age group, but MGM, Epcot and Universal may also see themselves as “kid-friendly” for this age group, but in fact are not recommended for children under six as there just isn't enough to engage them for any length of time.

The system of the invention groups children in three logical groupings. Children 0-5, 6-12, and teens. The system also has a category for children over 18, for parents who are traveling with their adult children. There isn't a material difference to how the system operates for the over 18 category, but it allows for all of the possibilities. For each age group the system has fuzzy logic that groups various elements of information about a venue to determine if it is “Age Appropriate”, “Age Recommended” and/or “Kid Friendly” for the specific age group. As an example, the Omni Hotel in Champions Gate in Orlando can't designate itself as Kid-Friendly. That has to be achieved by having the elements that are deemed to make a hotel kid-friendly for each category. This includes having a kids' program, a pool, an arcade, etc., depending on the age group. This same fuzzy logic is also applicable for other “friendly” categories, such as Biker Friendly or RV Friendly. In those cases, we take into consideration the tarmac, the parking lot lighting, ability to turn around without having to back up and other attributes that would attract a biker or RV enthusiast. The system also takes complaints and other user feedback about the user group into consideration in calculating the “friendly” attribute.

The RoadTrip Wizard™ allows the user to easily manipulate the service and its results based on any number of preferences and its Advice Engine plays a role throughout the travel planning process. For instance, and as stated, there are other mapping providers in the marketplace, but none of them builds a trip itinerary and breaks it out day-by-day based on the number of miles the traveler has said they want to cover in a given day. If there is a day that goes beyond the mileage limit (there are scenarios where this can occur, especially in the United States), the Advice Engine flags the problem and the user is presented with tools to adjust the day and its activities, or not. If the user inserts a day or two as a stopover, the Advice Engine will flag a scheduling conflict if there is one (e.g. a booked event or desired activity further along the route, for example). If the user is trying to cram too many activities into too short a time frame, the Advice Engine will say so. The user can accept the “advice” and make changes, or not. The product roadmap includes adding the ability to return to a given point of interest, such as a hotel or campground or your aunt's house in Akron, each night on a multi-night stopover

Road trips can be built and stored for future reference or to share with friends and fellow travelers. They can be retrieved, amended and saved anew. Finally, the end product of this travel planning and purchase process is provided to the user in all manners of media currently available, be it as a robust, customized printed itinerary (by day, summary or the detailed full trip plan and itinerary) or a digital file for upload to a desktop, PDA, personal navigation device or GPS system.

Additionally, the same tools that allow creation of an eTwin for an individual can also be used to tailor the Trip Wizard to a totally different audience, such as the easy creation of a Motorcycle Enthusiast Trip Wizard or a Seniors Trip Wizard or a Golf Travel Wizard. It is the thoughtful integration of powerful user profiling tools and hitherto disparate or unavailable services, combined with an entirely novel buying metaphor, that distinguishes the Journey Wizard and Advice Engine from any systems or services available in the prior art.

Once the trip plan is complete, the system displays the user's choices on the Trip Plan, which allows the user to move trip elements around until they are ready to produce the route. The system then produces a day-by-day trip plan, the ideas for that trip and a route, including individual maps for each day. It can also show the “fit” of the selected trip elements to the Persona. This is portrayed on the “Fit-O-Meter”, which is a graphical element that shows an Excellent fit with the color green, a Good fit with yellow and a So-So fit with red, similar to a stop light. When the user clicks on the Fit-o-Meter, it will display the general rule violations that created the status. As an example, if the user normally travels with their pet and forgets to uncheck it, then they ask for a listing of all hotels versus those that are filtered, and book a hotel that is not pet-friendly, that would yield a So-So fit. The legend would indicate Pet Friendly as the item that did not match the actual trip plan selections.

Enroute The TripPlan can be output to various internet enabled and mobile devices, including a personal navigation device, an in-vehicle GPS unit and to various handheld devices and can be accessed via the Internet and business processes are in place to allow the consumer to call a service center for the system of the invention to modify their trip itinerary and then have a copy emailed to them or faxed to a hotel enroute. This capability will not only provide the user with convenient information heretofore only available on a printed document, but will also extend the capabilities of those devices beyond their current intended use to make them truly “personal” navigation devices and also to make the product truly nomadic. The inventors contemplate an embodiment incorporating integration of this capability/invention into the seatback entertainment units on planes and ultimately on trains as well.

Post-Trip Sharing The system of the invention is capable of embedding social networking capabilities to allow sharing of trip tips, photos, journals, videos and trip feedback. While other systems also embed social networking, the system of the invention provides a solution that can utilize the trip feedback, coupled with business rules, as a unique and novel way to update the content in the system.

An example would be asking someone how they liked their hotel and receiving a response that they didn't accept pets, or that they charged a $100 pet deposit. The system can then change that attribute of the hotel's content record so that it is no longer recommended. Competitive systems have this information, but it is embedded in narrative feedback from users and the traveler has to read and assimilate and make their own decisions, versus having automatic filtering of that content up front.

The private label functionality of the system is designed to allow:
Unique content and inventory sources for each private label, with the ability to syndicate the content and inventory out to the entire Journey Wizard network or to hold it captive;
Ability to tailor business rules and the look and feel, including the mapping user experience layer;
Ability to suppress certain categories of content or functionality;
Ability to preset certain elements of the system, including the origin, destination, eTwin collections, preferences to match an enthusiast group, experience or genre;
A complete affiliate network within each private label client environment;
Ability to capitalize on advertising or other marketing programs already in place with the private label customer;
Online (and offline) customer support to provide site use guidance, as well as to focus on upselling and closing sales; and
Metrics and reporting program related to site statistics and user behavior while on the site, with separate statistics for each private label and each of their affiliates.

ContentBuilder The data model and matrix creates an intersection between the type of vehicle used for the trip—car, motorcycle, sports utility vehicle, recreational vehicle—with the theme of the trip desired—romance, relaxation, adventure, ecotourism, art and culture—with the person or persons traveling and any special needs and considerations, the time or date span available for the trip, accessibility to required services.

The data model and matrix supports scenarios that number into the thousands, and the interface renders this vast collection of data into an application that is not only easy to use, but in fact makes the whole planning process enjoyable.

The ContentBuilder application is a tool that is used both to import content from external sources (through the eBip module) and to augment that content with “tags” known as attributes, as well as to build additional content records manually.

Content in our system is defined as:
Points of interest (places, cities, regions), such as places to stay, places to shop, places to eat, things to do, places to go;
Events (both bookable/ticketable and informational); and
Maps and underlying information to support routing (average speed limits, road types, terrain and geographical information such as mountains and parks).

Although the invention herein has been described with reference to particular embodiments, it is to be understood that these embodiments are merely illustrative of the principles and applications of the present invention. It is therefore to be understood that numerous modifications may be made to the illustrative embodiments, and that other arrangements may be devised without departing from the spirit and scope of the present invention as defined by the following claims.

We claim:

1. A system for providing customized trip planning and related mapping and routing services comprising:
(a) a user interface device in effective network connection with a server;
(b) a means for viewing graphical content on the interface device;
(c) a database of trip, destination and activity-related information residing on or in connection with a server device;
(d) data storage media residing on or in connection with the server device;
(e) executable software means residing on the server device that delivers customized content derived from the database to the user of the interface device as a result of user data passed from the interface device to the server.

2. A method for providing customized trip planning and related mapping and routing information to an individual contemplating travel, the method comprising the steps of
(a) obtaining information from the individual contemplating travel, wherein the information relates to one or more of the following factors: who is traveling, what the individual may like to do while traveling, where the individual may be traveling, why the individual is traveling, when the individual may be traveling, and by what one or more means of transport the individual may be traveling;
(b) storing the information in one or more profiles specific to the individual;
(c) generating a trip plan for the contemplated travel customized to the individual, wherein the plan provides at least a route and an itinerary specifying locations, activities and schedules consistent with the individual's one or more stored profiles.
